(19) United States
(12) Patent Application Publication
(10) Pub. No.: US 2005/0051502 A1
(43) Pub. Date: Mar. 10, 2005

(54) Method for using auxiliary filtering agents for filtration purposes

(75) Inventor: Ludger Gottkehaskamp, Goggingen (DE)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/484,264

(22) PCT Filed: Jul. 9, 2002
(86) PCT No.: PCT/EP02/07624

(30) Foreign Application Priority Data
Jul. 18, 2001 (DE) 101 34 861.4

(51) Int. Cl. C02F 1/00

(52) U.S. Cl. 210/777

(57) ABSTRACT

The invention relates to a method for filtering liquids, especially biological liquids. A filter (1) is deposited with the auxiliary filtering agent during a pre-deposition phase. In an ensuing filtration phase, the infiltrate is filtered by adding an auxiliary filtering agent. The auxiliary filtering agent forms a filter cake during the pre-deposition phase and the filtration phase. The auxiliary filtering agent is deposited during the pre-deposition phase, the proportion of regenerated auxiliary filtering agent being 30%, especially 0%. During the filtration phase, an auxiliary filtering agent is added, consisting predominantly, especially almost fully, of regenerated auxiliary filtering agent. The regenerated auxiliary filtering agent is treated with a medium over the whole pH value spectrum.

The invention concerns a method for filtering liquids of the type indicated in the generic part of claim 1.

The use of diatomaceous earth, perlites and/or cellulose as filter aids in the filtration of liquids is known. For the filtration of biological liquids, in particular beer, a method is known from the periodical “Brauwelt [Brewing World],” No. 17, 1988, pp. 666 ff, in which regenerated diatomaceous earth is used as filter aid. The diatomaceous earth is regenerated with 4 to 5% sodium hydroxide at a temperature of 80° C. To use the regenerated diatomaceous earth for another filtration, it is mixed with 10 to 20% diatomaceous earth that has not been used. With repeated use of regenerated diatomaceous earth by this method, an uncontrollable increase of the change of the pressure differential per unit of time is seen.

The invention is based on the task of creating a method for filtering liquids of the generic kind, which enables the use of regenerated filter aids.

This task is solved by a method with the characteristics of claim 1.

Regenerated filter aid is usable on an industrial scale only if the process is controllable. It is important for this for the increase of the pressure differential, which is the difference of the pressures before and after the filter, to be controllable. As the inventor has established, the increase of the pressure differential per unit of time is highly dependent on the pressure differential at the start of filtration. If a filter aid that consists chiefly of filter aid that has not been regenerated is used in the precoating phase, the difference of pressure at the start of filtration will be low and the increase of the pressure differential will be controllable. Mainly regenerated filter aid can be used for the filtration phase, since it has only a small effect on the increase of the differential pressure. The use of 0% regenerated filter aid for the precoat phase and 100% regenerated filter aid for the filtration phase is seen as the optimum design of the process. The regenerated filter aid is treated with an agent in the entire pH spectrum.

Diatomaceous earth is expediently used as filter aid. However, cellulose and/or perlites with or without diatomaceous can also be used as filter aids. It is foreseen that the method includes a regeneration phase, in which the filter aid is regenerated, and the regeneration is carried out in particular in the filter. Expediently, the regeneration phase includes the treatment of the filter aid with an alkali solution. Preferably, sodium hydroxide in a concentration from 0.1 to 2%, in particular 0.5%, is foreseen as alkali solution. The substances that are to be removed from the filter aid are not dissolved in the sodium hydroxide solution at concentrations under 0.1%. At alkali solution concentrations over 2% the structure of the diatomaceous earth is attacked, due to which the diatomaceous earth forms smaller interstices for the liquid in the precoat layer and thereby the pressure differential of the precoat rises considerably.

Expediently, the regeneration is carried out with alkali solution at a temperature from 60° C. to 90° C. It is further foreseen that the filter cake is rinsed with hot water, which in particular has a temperature from 40° C. to 90° C., before the alkali solution treatment. Preferably, after the treatment with alkali solution, the alkali solution is displaced with hot water and with cold water. To neutralize the alkali solution it is foreseen that the filter aid is treated with an acid, in particular with nitric acid, and this process step is expediently carried out after the alkali solution has been displaced with hot and cold water. For a subsequent step it is foreseen that the acid is displaced with cold water and the liquid is then allowed to be drained from the filter. Expediently, the filter aid is resuspended at the end of the regeneration phase.

An embodiment example of the invention is illustrated in more detail by means of the drawing. Here:

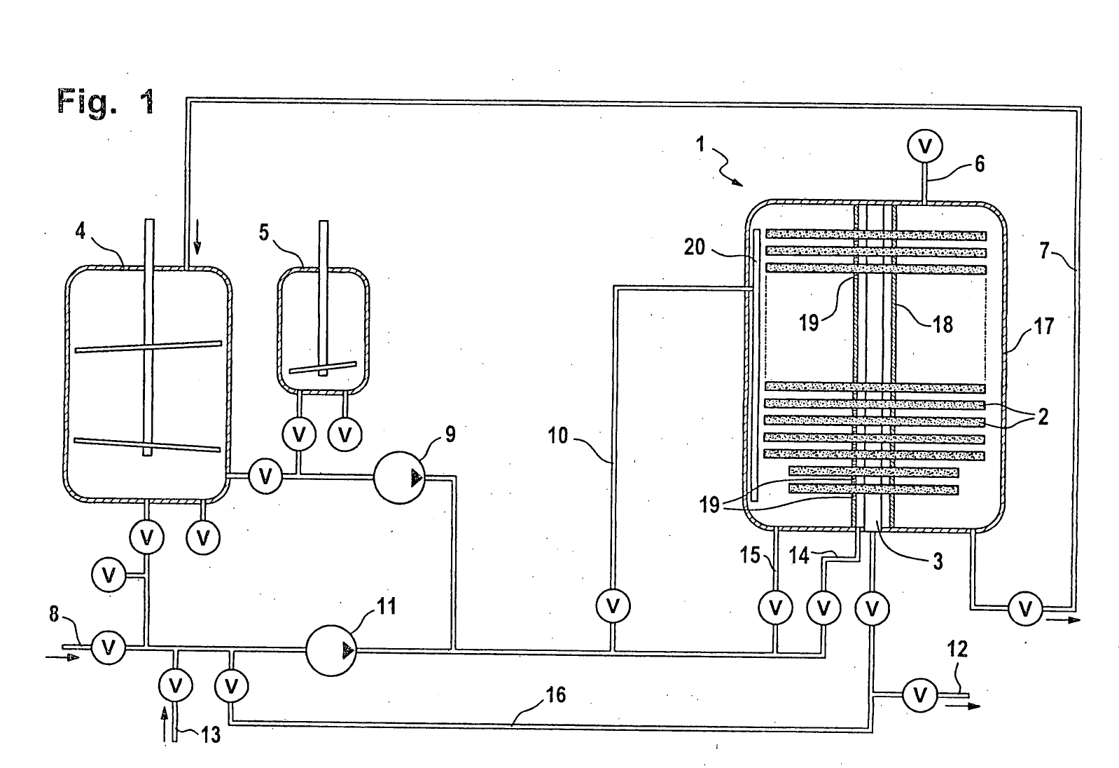

FIG. 1 shows a plant drawing of a block plant for conducting the method,

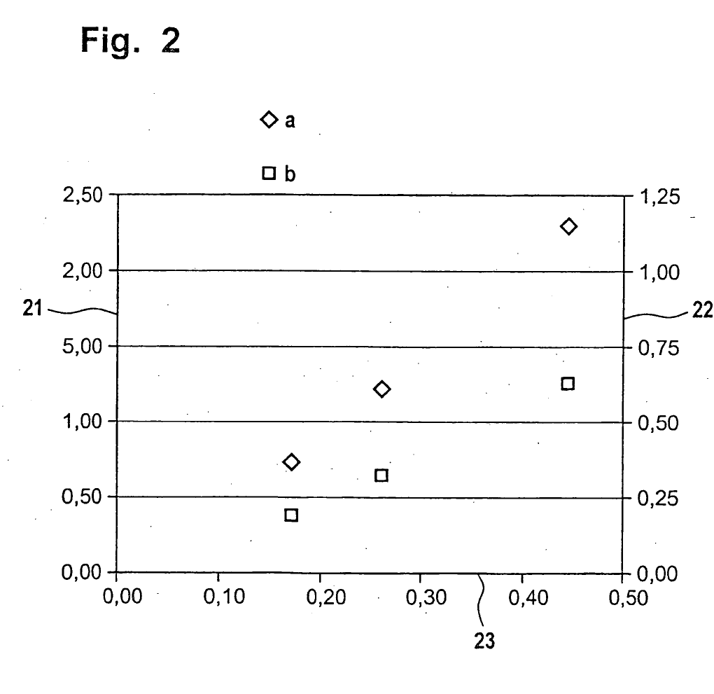

FIG. 2 shows a graphical representation of the dependence of the pressure differential at the end of filtration on the pressure differential at the start of filtration.

FIG. 1 shows a plant diagram of a block plant for precoat filtration, in which is schematically represented a filter 1, which is designed as a centrifugal horizontal filter. Filter 1 consists of a housing 17 with filter elements arranged in it consisting of disk shaped filter cells 2 stacked one on the other and a central channel 3. The central channel 3 lies downstream from the filter element packet and therefore forms the filtrate side, while the space between the filter cells 2 and the housing 17 of filter 1 forms the feed side. To deliver the feed, the filter 1 has a hollow shaft 18, which is arranged coaxially to central channel 3 and surrounds this channel, forming an intermediate space for delivery of the feed. The hollow shaft 18 has orifices 19, through which the feed can flow to the feed side of the filter cells 2. Instead of the filter elements, the filter 1 can also contain a cartridge filter as filter surface. Filter 1 has an air escape 6. From the feed side a drain pipe 7 leads to a tank 4, which contains regenerated diatomaceous earth as filter aid. Another tank 5 contains “neugur,” i.e., diatomaceous earth that has not been regenerated. Cellulose and/or perlite can also be added to the diatomaceous earth as filter aid. It is also possible to use a filter aid that consists only of cellulose and/or perlite. The addition of silica gel is also possible, but silica gel cannot be regenerated and must therefore be readded to the regenerated filter aid.

Before the beginning of filtration the filter 1 is coated from tank 5 via a refill pipe 15 with filter aid that has not been regenerated, for example diatomaceous earth, where the diatomaceous earth is deposited in particular with water. The precoating is dependent on the filter material and can amount to for instance 600 g filter aid for m² filter area. The diatomaceous earth is, for the coating, transferred via pump 9 and feed conduit 14 to the feed side of filter cells 2 of filter 1. During the precoating the diatomaceous earth can be mixed with up to 30% regenerated diatomaceous earth from tank 4.

After precoating, the feed is conveyed to the feed side of filter 1 via the feed line 8 by means of pump 11 through the feed line 14 into the hollow shaft 18 and through the orifices 19. Regenerated diatomaceous earth from tank 4 is added to the feed via pump 9, and a portion of not regenerated diatomaceous earth from tank 5 can also be added. The filtrate, after filtration, leaves filter 1 via filter outlet 12. The filtration is interrupted if the pressure differential at filter 1 reaches a preset value or if the filter cake that is formed through the added filter aid reaches a preset size.

After stopping filtration the filter aid or the diatomaceous earth in filter 1 is regenerated. For this filtrate that is still in filter 1, especially if after interrupting filtration the quality of the filtrate could no longer be ensured, is sent back to the feed. The feed is diverted. Then the filter 1 is filled with hot water, which can have a temperature of about 40° C., and the filter cake is flushed at a temperature rising to about 90° C. After the rinsing operation, sodium hydroxide is added so that an approximately 0.5% sodium hydroxide solution results. However, potassium hydroxide solution can also be used. The alkali solution temperature is about 60 to 90° C. The sodium hydroxide solution is circulated through the diatomaceous earth. The treatment of the diatomaceous earth with sodium hydroxide solution can take about 30 minutes, for example. Then the alkali solution is displaced with hot water and cold water. As this happens it is cooled to about 20° C. In the next step of the method nitric acid is added and the diatomaceous earth is rinsed with it, for example for 5 minutes. The nitric acid is then displaced with cold water and then the remaining liquid is drained from filter 1.

To resuspend the filter cake, the filter element packet is set into rotation and the filter cake is spun off. The regenerated filter aid slurry that is trapped in the lower part of filter 1 is forced back to tank 4 via drain pipe 7 by means of gas. During the cleaning of the filter the filter elements 2 can be sprayed off by means of a spray strip 20 arranged in the filter housing 17. The spray strip 20 is supplied from a feed pipe 10.

FIG. 2 shows the relationship between the pressure differential at the end of filtration a and the change of the pressure differential per unit time b against the pressure differential at the start of filtration. The pressure differential at the start of filtration a is plotted on the axis 21, while the change of the pressure differential at the end of filtration b is plotted on axis 22, and the pressure differential at the start of filtration is plotted on axis 23. It is clear from the diagram that the pressure differential at the end of filtration a and the pressure differential per unit of time b are considerably dependent on the pressure differential at the start of filtration. The smaller the pressure differential is at the start of filtration, the lower will be the pressure differential at the end of filtration a and the change of the pressure differential per unit of time b. Precoating with filter aid that has not been regenerated produces a low pressure differential at the start of filtration and thereby a low pressure differential at the end of filtration a as well as a low increase of pressure differential per unit of time b.

The method for filtering liquids can be used in particular for biological liquids. It is important for the regeneration of the filter aid with alkali solution that the substances that are filtered out be soluble in alkali solution.

The method can be used in today's precoat filters. Tank filters like horizontal filters or cartridge filters are favorable for the use of the method, but the method can basically also be used in frame filters as well. The method can also be used in combination with the method for stabilizing tannin- or protein-containing liquids, for example with PVPP, or with a method in which a prepared filter cake is used.

1. A method for filtering liquids, in which a filter is precoated with filter aid in a precoating phase and feed is filtered while adding filter aid in a subsequent filtration phase, where the filter aid forms a filter cake on the filter in the precoating phase and the filtration phase,
wherein in the precoating phase, filter aid is deposited in which the amount of regenerated filter aid is <30%, and filter aid is added in the filtration phase that chiefly consists of regenerated filter aid, where the regenerated filter aid has been treated with an agent in the range of the overall pH spectrum.

2. A method as in claim 1, wherein in the filtration phase filter aid is added that consists nearly entirely of regenerated filter aid.

3. A method as in claim 1, wherein diatomaceous earth is used as filter aid.

4. A method as in claim 1, wherein cellulose and/or perlite with or without diatomaceous earth is used as filter aid.

5. A method as in claim 1, wherein silica gel and/or PVPP is added to the filter aid.

6. A method as in claim 1, wherein the method includes a regeneration phase, in which the filter aid is regenerated.

7. A method as in claim 6, wherein the regeneration is carried out in the filter.

8. A method as in claim 6, wherein the regeneration phase includes the treatment of the filter aid with an alkali solution.

9. A method as in claim 8, wherein the alkali solution is sodium hydroxide solution in a concentration of 0.1 to 2%.

10. A method as in claim 8, wherein the regeneration with alkali solution is carried out at a temperature from 60° C. to 90° C.

11. A method as in claim 8, wherein the filter cake is rinsed with hot water before the treatment with alkali solution.

12. A method as in claim 11, wherein the hot water has a temperature from 40° C. to 90° C.

13. A method as in claim 8, wherein after treatment with alkali solution the alkali solution is displaced with hot water and with cold water.

14. A method as in claim 6, wherein the filter aid is treated with an acid.

15. A method as in claim 14, wherein the filter aid is treated with nitric aid.

16. A method as in claim 14, wherein the treatment with acid is carried out after displacing the alkali solution with hot water and with cold water.

17. A method as in claim 14, wherein the acid is displaced with cold water and the acid is then allowed to drain from the filter.

18. A method as in claim 6, wherein the filter aid is resuspended at the end of the regeneration phase.

19. A method as in claim 1, wherein the method is carried out in combination with a method for stabilizing tannin-containing liquids.
